(19) United States
(12) Patent Application Publication
(10) Pub. No.: US 2007/0143863 A1
(43) Pub. Date: Jun. 21, 2007

(54) COPY-RESISTANT READ-ONLY DIGITAL OPTICAL DISC AND ADAPTABLE PLAYER

(75) Inventors: Han Zou, Windsor, NJ (US); Terence J. Nelson, New Providence, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/676,607

(22) Filed: Feb. 20, 2007

Related U.S. Application Data
(62) Division of application No. 09/640,360, filed on Aug. 16, 2000.

(51) Int. Cl. G06F 17/30

(52) U.S. Cl. 726/33

(57) ABSTRACT

A copy-resistant read-only digital optical disc having encrypted digital data. The copy-resistant read-only digital optical disc includes a digital work, a variable user-data format encoding said digital work after encryption with a variable software algorithm, an implementation of said variable software algorithm, and an implementation of said variable user data format encoded in a default format. The encrypted digital data is read on an adaptable digital optical disc player. which is adaptable to a user-data format described on said copy-resistant read-only digital optical disc made in accordance with this invention. A copy-resistant read-only digital optical disc made in accordance with this invention will provide necessary user-data format information on the disc in a default format, which is always accessible by a legacy player.

### CROSS-REFERENCE TO RELATED APPLICATIONS

This application is a divisional of U.S. patent application Ser. No. 09/640,360 filed on Aug. 16, 2000. The disclosure of the above application is incorporated herein by reference.

### TECHNICAL FIELD

This invention relates to digital optical disc. and more particularly to a copy-resistant read-only digital optical disc having encrypted digital data and its application in distribution of copy-protected content.

### BACKGROUND OF THE INVENTION

The present invention relates to the dilemma that confronts digital audio and video content providers as writable storage media inevitably become comparable in cost with read-only media that play in the same devices. At the same time, home computers have become common, if not ubiquitous, and peripheral drives that can transfer information to writable media are increasingly affordable. Naturally, these drives can also read the digital content from read-only media, so even a nominally honest user can be tempted to make unauthorized copies. This scenario is now affecting the digital audio market because CD-R (write-once) discs have become very inexpensive.

Video DVD content is disguised by the Contents Scramble System (CSS). CSS provides that unscrambled digital video outputs are not provided on consumer-market players. Also, unscrambled digital video outputs are not provided on consumer-markel DVD-players, and current DVD-ROM drives that play video DVD discs output scrambled content to a separate hardware decoder. But, CSS alone cannot prevent a consumer player from playing sector-by-sector copies of protected content on writable discs with a compatible format. The details of CSS system are not supposed to be public knowledge, but a general description was given by Michael Moradzadeh of Intel in “Licensing Requirements for the CSS DVD Copy Protection Method”. Intel, 1997.

To inhibit playback of unauthorized sector-by-sector copies, a group of companies known as the 4C Entity proposed “Content Protection for Recordable Media” (CPRM) which is available from 4C License Entity LLC, 225B Cochrane Circle, Margan Hill, Calif. 95037. CPRM uses a “Protected Media Identifier,” when scrambling and unscrambling content. This ensures that protected content copied directly from one disc to another cannot be played back because the identifications would not match. However, CPRM does not prevent scrambled content from being copied onto a writable disc sector-by-sector, which could be the first step in illegally voiding the copy protection of a digital disc.

A sector-by-sector copy of a CPRM disc would only lack the media identifier of the original disc, which an adversary could read and try to provide during playback from an unauthorized copy. This might require only limited reverse engineering of CPRM's decryption algorithm in a software implementation on a personal computer.

Copy protection generally endangers backward compatibility of future players. Even if copy protection were to be abandoned however, the rapid evolution of optical disc technology threatens to make old discs unreadable in future players.

In spite of the teachings of the above mentioned, there is still a significant need for a copy-resistant read-only digital optical disc having encrypted digital data.

It is therefore a principal object of the present invention to provide a variable disc format that players can read but can nevertheless be changed as necessary to make sector-by-sector copying onto writable discs infeasible.

It is still another object of the present invention to provide variable software algorithms for encrypting a digital work which can be updated or even changed completely while still maintaining playability in existing players.

It is yet another object of the present invention to provide future players or drives a method of adapting to antiquated discs using information provided on the discs themselves.

### SUMMARY OF THE INVENTION

The present invention is directed to a copy-resistant read-only digital optical disc having encrypted digital data and to providing digital content on read-only discs that are hard to copy because the format of the information is unpredictable. The content is furthermore encrypted with an algorithm that is chosen at the time the distribution discs are mastered. The key to these advantages is a player architecture that adapts to the user-data disc format from configuration information that is provided on the disc in a default format. This configuration information will also provide a way for future generations of players to play these discs when full backward compatibility will be hard to maintain in hardware.

In a preferred embodiment of the invention, the apparatus of the present invention includes a choice of a user-data encryption algorithm whose implementation is not publicly available. After encryption of the work is completed, a user-data format that is incompatible with known writable disc formats is chosen. The encrypted digital work is then encoded in the user-data format to prevent sector-by-sector transfer of the content onto to a writable disc. Another format may be chosen for new titles if. with the passage of time, writable discs become available. A description of the user-data format used on a particular disc is written on the disc itself in a default format. Similarly, object code for the decryption process is placed on the disc in the user-data format. If, with the passage of time, decryption becomes reverse engineered to permit unauthorized playback, new algorithms may be chosen as necessary to protect new titles.

In an alternative preferred embodiment, the apparatus of the present invention includes architecture that makes it possible for a player to read data from a copy-resistant read-only digital optical disc having encrypted digital data in a format that cannot be anticipated during the design of the player and must be discovered from the disc itself. Because the player is designed to accept data in such formats from read-only discs, physical player functions such as focusing and tracking and acquiring a channel-signal may be performed with prior-art solutions. User-data is extracted from the channel-signal in two steps. In a first step, the channel-clocks and data have to be extracted from the channel-signal. This function is performed by a programmable channel-clock-generator that is initialized with information provided about the user-data format.

In a second step of user-data extraction, the process includes a synchronizing task. This is accomplished by waiting for a unique channel-bit sequence called a sync code. Multiple sync codes may be defined and the principal requirement is that they are not present anywhere in a sequence of concatenated code words representing data bytes. The simplest use of such flags is to identify the starting channel-bit of a first code word in a sequence of code words of predetermined length. Various synchronization processes are performed in order to access code word sequences representing various data structures that are allowed by the user-disc format. The conversion of code words to data bytes may be accomplished by the use of a conventional look-up table.

The present invention interprets the user-data format with the help of a single-steppable processor (SSP) architecture. Instruction executions are synchronized with the channel-bit clock when the SSP is performing a real-time tasks. This synchronization allows channel-bit clock cycles to be counted implicitly in the assembly language representation of the instructions. The SSP must be able to complete any instruction used in less than the channel-bit clock cycle time. The SSP actually performs this synchronization by using the channel-bit clock to trigger single-step instruction executions. The single-step mode is enabled by a flip-flop that is clocked by the channel-clock and cleared by a signal from a microprocessor that signals an instruction fetch. One of the microprocessor bits which initializes to zero is used to override the single-step mode. When the microprocessor sets that bit, it enters single-step mode with the next instruction fetch.

### BRIEF DESCRIPTION OF THE DRAWINGS

The various advantages of the present invention will become apparent to those skilled in the art after reading the following specification and by reference to the drawings, in which:

FIG. 1 illustrates the method by which a digital work is transferred to a read-only media in a format that adaptable players can read but is incompatible with writable discs:

FIG. 2 illustrates a read-only disc carrying marks that represent a digital work encoded in a user-data format and a description of the user-data format encoded in a default format;

FIG. 3 illustrates an adaptable player that reads a digital work in a user-data format from a read-only optical disc by first reading a description of the user-data format in a default format and then using the description to adapt to the user-data format;

FIG. 4 illustrates a programmable-sequencer that performs real-time functions that enable a player to adapt to a user-data format on a read-only disc which is specified by a description on the disc in a default format;

FIG. 5 illustrates a single-steppable processor that can execute instructions in one-to-one correspondence with channel-bit clock pulses and is programmed to capture sequences of channel-bits representing data;

FIG. 6 illustrates timing of signals responsible for maintaining synchrony between a single-steppable processor and channel-bit clock pulses;

FIG. 7 illustrates a programmable channel-bit converter that can execute channel-bit clock signals from a channel-signal stream and convert a channel-signal stream to a channel-bit stream based on channel-configuration data;

FIG. 8 illustrates a method by which the controller controls the adaptable player to read specified data from a disc in the user-data format;

FIG. 9 illustrates a method by which the programmable-sequencer reads the address of the next sector appearing in the channel;

FIG. 10 illustrates a method by which the programmable-sequencer reads the data of the next sector appearing in the channel;

FIG. 11 illustrates how a sector of data is made up of SYNC codes and address and data code words; and

FIG. 12 illustrates the steps by which a sync code of a fixed number of bits is accepted.

### DETAILED DESCRIPTION OF THE PREFERRED EMBODIMENT

In order to make a sector-to-sector copy of a read-only disc with protected content possible. both formats of the read-only disc and the writable disc have to be compatible. If all writable discs on the consumer markets do not have formats compatible with that of read-only discs with protected content, making a sector-to-sector copy becomes impossible. This obstacle may be compromised at a future date, but by that time read-only discs can adopt another new format to maintain incompatibility with currently available writable discs. Recognizing that new format adopted by read-only discs according to this invention may be unknown to legacy players, this invention also provides a design concept for both discs and players to maintain new player's read compatibility with old disc formats and vice-versa. A disc made in accordance with this invention will provide necessary user-data format information on the disc in a default format, that is always accessible by a legacy player. A player made in accordance with this invention is adaptable to a user-format described on a disc made according to this invention.

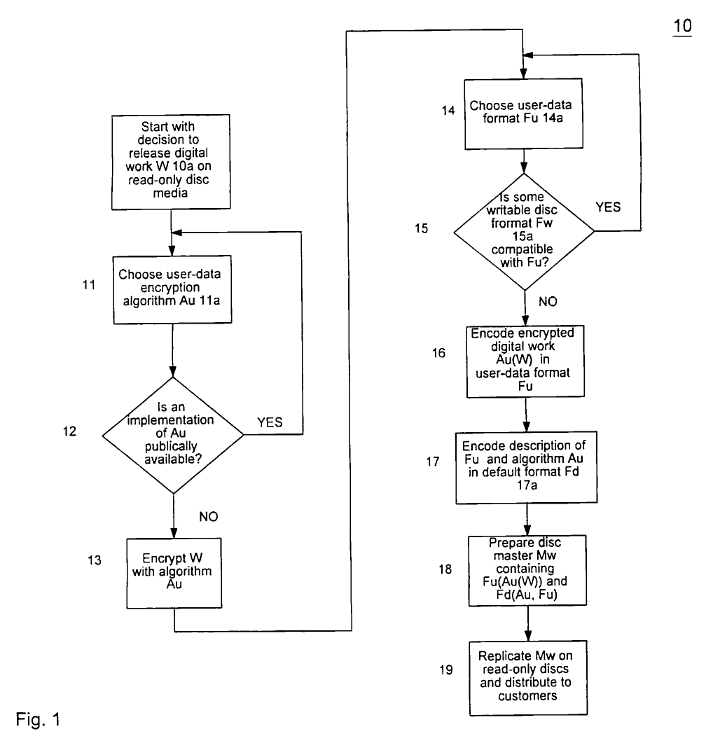

In accordance with the above-mentioned, FIG. 1 shows the main steps of a method 10 of the present invention for transferring a digital art work W 10a to a read-only media with maximum protection. First, a content provider will choose a user-data encryption algorithm Au 11 a whose implementation is not publicly available. After encryption is completed, the content provider may want to choose a user-data format Fu 14a, that is not compatible with known writable disc formats Fw 15a to prevent sector-to-sector copy by writable devices on the consumer market. Then, a description (or an implementation) |(Fu) of the user-data format Fu 14a including an implementation of error-correction decoding (ECC) will be encoded in a default format Fd 17. A description (or an implementation) |(Au) of the user-data encryption algorithm Au 11 can be considered as part of user-data and can be provided as needed. Both format description data and user-data are written to the master disc. that is replicated on read-only disc. This insures two levels of protection for user-data; one is at the encryption level, and the second is at the format level.

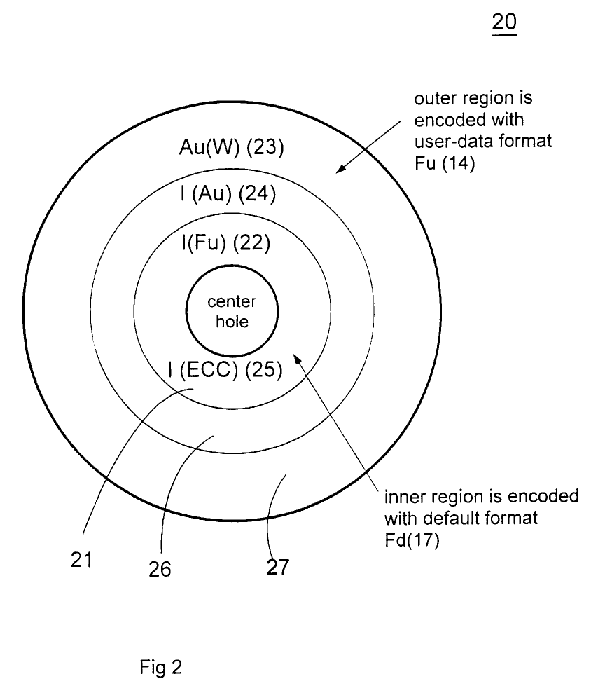

In FIG. 2 a schematic layout of a disc structure is depicted according to this invention, the description of user-data format |(Fu) 22, including an implementation of ECC-decoding 25 is recorded in a default format in the inner part 21 of the disc and the user-data encrypted by algorithm Au 11 is recorded in user-data format as AU(W) 23 in the outer part 27 of the disc. The implementation of the user-data encryption algorithm |(Au) 24 is recorded in the user-data format Fu 14, but in an area 26 that is directly accessible only by a drive's controller and is “invisible” for any file-system application. Since reading a disc normally starts at the inner part 21. a drive (not shown) would expect to read user-data format description first in a default configuration. A player according to this invention is able to adapt itself based on the user-data format description recorded in a default format to access user data. Such adaptation consists of two parts. The first part is the hardware reconfiguration, such as focus adjustment, reading wavelength, tracking strategy and so forth. For replicated content, this kind of hardware reconfiguration is minimal. The second part is instruction for a real-time process to convert the channel-signal stream to a data-bit stream and to decode raw data stream to application data stream as needed. To insure flexible adaptation, in order to perform requested conversion and decoding a player of this invention may use a pure software implementation as long as a desired data rate is maintained.

In addition to a software implementation a hybrid design in which hardware efficiency and software flexibility are combined is possible and can be very efficient. In this embodiment of the invention, a high-efficiency hybrid implementation scheme is based on a single-chip microprocessor.

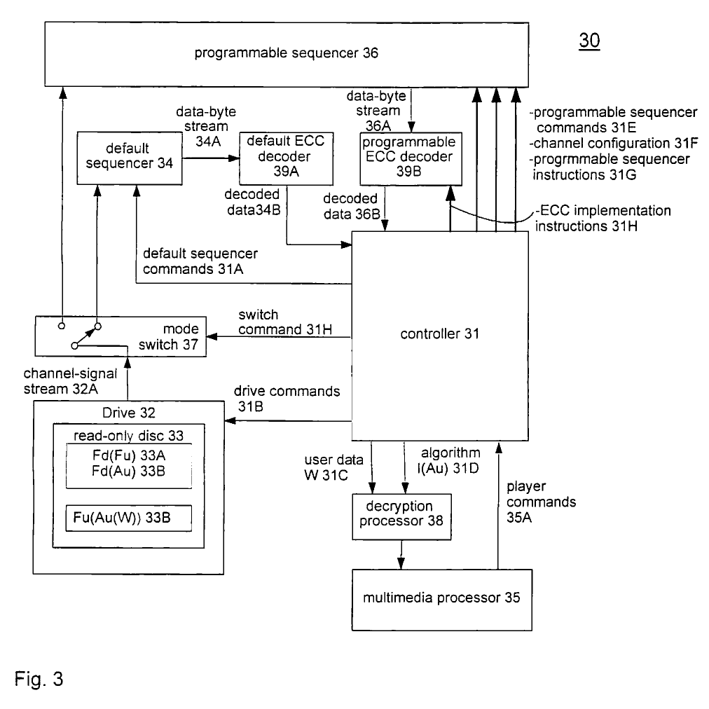

The block diagram in FIG. 3 demonstrates the concept design of a player 30 that has a real-time processing capability based on this invention. Functions of its individual parts can be explained by following a typical reading process. Once a disc of the present invention is inserted into a drive 32 of the player 30, under the instruction of a controller 31, the drive tries to read the description of the user-data format in an area 21 on the disc in a default format (Fd) 17 and generates a corresponding channel-signal stream 32A. A model switch 37 directs the channel-signal stream 32A to a default sequencer 34 that under instruction of default sequencer commands 31A. converts the channel-signal stream 32A to a data-bytes stream and forwards it to the default ECC-decoder 39 A that returns the decoded data to the controller 31 for further interpretation. From the description data, two groups of instructive data are generated by the controller 31: a group of drive commands 31B for necessary reconfiguration and a group of real-time processing instruction including programmable-sequencer commands 31E, channel configuration 31F, programmable-sequencer instructions 31G, and programmable ECC-decoder instructions 31H. The controller starts an adaptation process by sending the reconfiguration commands to the drive 32 for necessary reconfiguration, the programmable-sequencer commands 31E. channel configuration 31F and programmable-sequencer instructions 31G to a programmable-sequencer 36 for the required real-time conversion, EEC-decoder instructions 31H to the programmable ECC-decoder 39B to perform real-time ECC-decoding and a switch command to the mode switch 37 to direct the channel-signal stream to the programmable-sequencer.

If the user-data format is the same as the default format, the player 30 will read the user-data in the default configuration. In a mode adapted to a user-data format, the controller 31 obtains a user-data stream from the programmable-sequencer 36 and interprets it as needed. From the user-data stream, the controller 31 generates two typical types of data: user data 31B and an implementation of the encryption algorithm |(Au) 31C, and forwards them to a decryption processor 38 if necessary and finally to an application processor 35. that can be, for example, a multimedia processor.

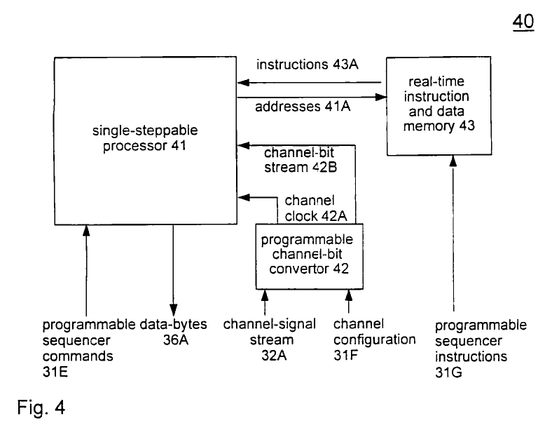

While different implementation schemes are possible to perform the functions of individual blocks depicted in FIG. 3, FIG. 4 discloses a conversion process block diagram inside the programmable-sequencer 36 which is designated as No. 40.

The task of a programmable-sequencer 36 is to convert the channel-signal stream 32A to the corresponding data-byte stream as depicted in FIG. 4. Within the channel-signal stream 32A, both overhead and user-data are encoded. The overhead part includes channel-bit clock signal 42A, stream-position signal and other identification signals. The conversion consists of two steps: first, a programmable channel-bit converter 42 recovers a channel-bit clock signal 42A and the associated channel-bit stream 42B from the channel-signal stream 32A; second, a single-steppable processor 41 converts the channel-bit stream 42B to a data-byte stream 36A based on the conversion algorithm described by the programmable-sequencer instructions. Before the real-time process starts, the controller 31 sets a single-steppable processor 41 in its ready state by issuing at least one programmable-sequencer command 31E, sets the mode of the programmable channel-bit converter 42 by sending channel configuration and loads programmable-sequencer instructions into a real-time instruction memory 43. At the commencement of reading user-data, the programmable channel-bit converter 42 receives channel-signal stream 32A continuously. Using the channel configuration, the programmable channel-bit converter 42 extracts the embedded channel-bit clock signal 42A and consequently converts the channel-signal stream to channel-bit stream 42B. Both channel-bit clock signal 42A and channel-bit stream 42B are forwarded to the single-steppable processor 41. Under instruction of at least one programmable-sequencer command from the controller 31 and in response to a start instruction, the single-steppable processor 41 enters a single-step mode in order to perform real-time conversion in synchrony with the channel-bit stream. The single-steppable processor 41 receives the start instruction from the instruction memory 43. After execution of the first instruction in the initial address, the single-steppable processor 41 goes into a waiting state until the next channel-bit clock cycle. Once the next channel-bit clock cycle arrives, the single-steppable processor 41 outputs the second address, loads the second instruction from the memory 43 and executes it. This process keeps running in synchrony with the channel-bit clock cycle until all required instructions are executed. Finally, the single-steppable processor returns a data-byte stream to the programmable ECC-decoder 39B.

The choice of the single-steppable processor 41 and the design of executable instructions have to guarantee that each execution cycle is shorter than a channel-bit clock cycle and the total number of executions required to read a code word is less than the number of channel-bits contained in one code word. Further. in FIG. 4, the programmable channel-clock generator 42 and the real-time instruction memory 43 are shown as separate blocks. However, in an engineering construction, they can be integrated into a single physical chip with the processor.

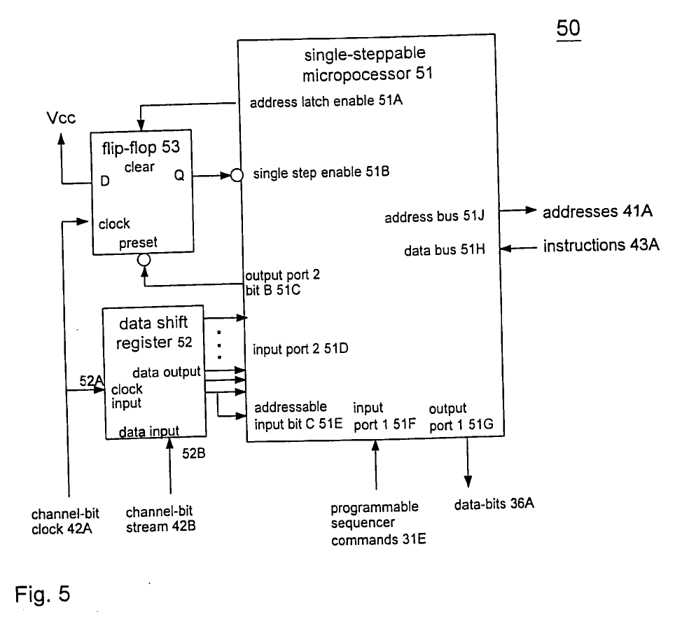

In FIG. 5. the organization of the single-steppable processor (41, 50) is shown. A single-steppable microprocessor 51 executes instructions in one-to-one correspondence with an external channel-bit clock cycle and is programmed to capture sequences of channel-bit representing data. A shift register 52 is clocked by the external channel-bit clock and used to buffer incoming channel-bit stream. The register 52 has a serial data input for receiving channel-bit stream and a parallel data output for sending channel-bits in a fixed word length. A flip-flop circuit 53 is also clocked by the external channel-bit clock and has a logic gate function: enable single-step mode of the microprocessor 51 in correlation with completion of execution and the external channel-bit clock 42A. The microprocessor 51 powers up in a free-running mode before entering a single-step mode on receiving a start instruction. This start instruction sets an output high at bit B of output port 2 and consequently sets the preset at the flip-flop 53 to low, enabling the single-step mode to be entered following the completion of the start instruction. Thereafter, the microprocessor 51 executes one instruction in response to each channel-bit clock pulse, which clocks Vcc at the data input of the flip-flop. While preset is low, the microprocessor remains in single-step mode because the first address-latch-enable pulse of each instruction clears the flip-flop. When all conversion instructions are executed. the address-latch-enable output port on the microprocessor 51 can send a pulse to disable the current single-step mode.

If all executions are completed before a fixed word length of channel-bit stream is read, the microprocessor 51 will enter a waiting state until the next process cycle starts. This waiting state can remain in the single-step mode, but without execution of any conversion instruction. or enters into a “free-running mode” by setting the output port to low disabling the current single-step mode. When the preset is high the microprocessor remains in free-running mode because the preset input of the flip-flop takes precedence over the clear-input.

During a contiguous real-time process, the channel-bit stream 32A is read into the shift register 52 at a constant rate in synchrony with the channel-bit clock and output in parallel in a fixed word length.

The synchronization relationship between steps described above, is shown in FIG. 6 as waveforms.

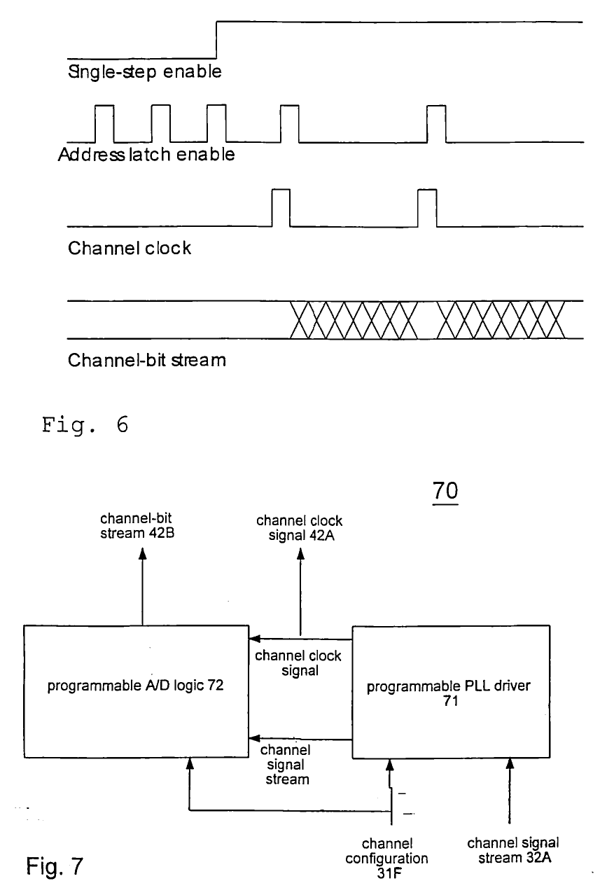

FIG. 7 depicts an embodiment of the programmable channel-bit converter 42 described in FIG. 4. A programmable phase-lock-loop (PLL) driver 71 extracts channel-bit clock signals 42A based on the channel configuration or given reference data patterns. With the present channel-bit clock signal 42A as temporal reference and given channel configuration 31F as conversion algorithm, the analog channel-signal stream is converted to a binary channel-bit stream 42B by a programmable analog-to-digital (A/D) converter 72.

After disclosing the design concept at component levels, real-time operation will be disclosed by example methods of reading data from a requested sector on a disk.

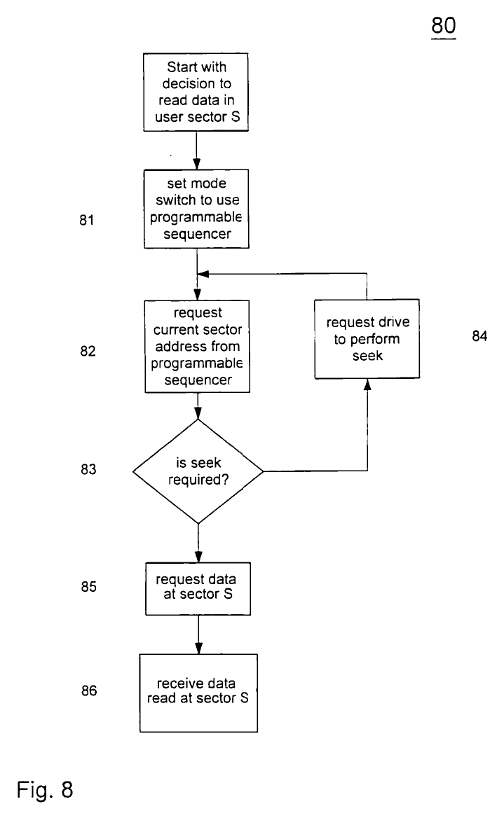

The flow-chart in FIG. 8 shows the main steps of an example method 80 of reading data from a requested sector.

Reading begins with step 81, where the controller issues a command to the mode switch 37 in FIG. 3 to direct the channel-signal to the programmable-sequencer 36. Then, at step 82 the controller requests the current sector address, where the read head is currently located, from the programmable-sequencer. If the current address does not match the requested sector address, the controller decides that a seek is required and moves to step 83 by issuing a seek command to the drive to find the requested sector. If the current address matches the requested sector address, the controller moves to step 85 to instruct the drive to read the data from the current sector. At step 86, the controller receives the requested data. If data in more than one sector of a disc should be read the steps shown in FIG. 8 are repeated until all requested data have been read.

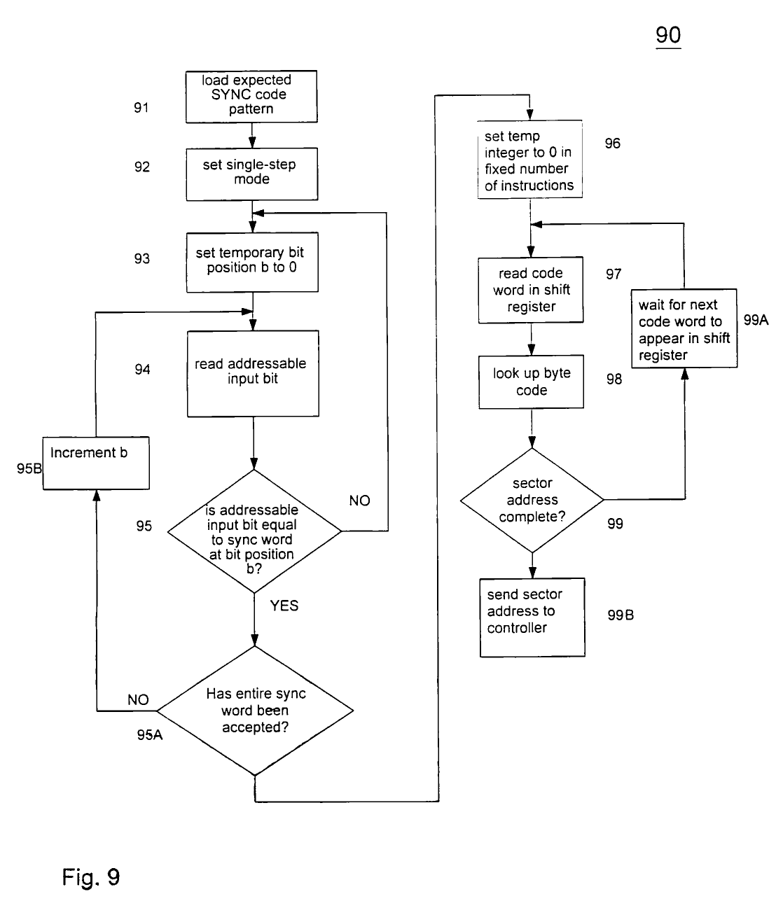

Two basic operations are involved in method 80. The first operation reads sector addresses, and the second reads the requested data when the requested address is detected. FIG. 9 shows major steps of reading a requested sector address. The hardware design concept that this operation is based on has been described in FIGS. 4 and 5. It is usually advantageous to move the head radially in an operation called a seek. After a seek, the exact location of the head on the track is not known. As a common practice in optical-storage technology, unique codes are used to mark reference positions in a channel-bit stream. In particular, a SYNC code has a unique pattern that cannot be matched in any segment of equal length in the data portion of a channel-bit stream. A unique SYNC code is embedded in a channel-bit stream preceding a sector address by a fixed number of channel-bits.

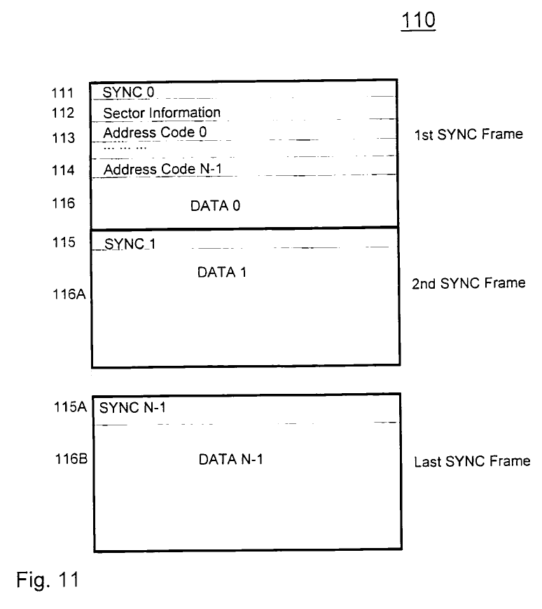

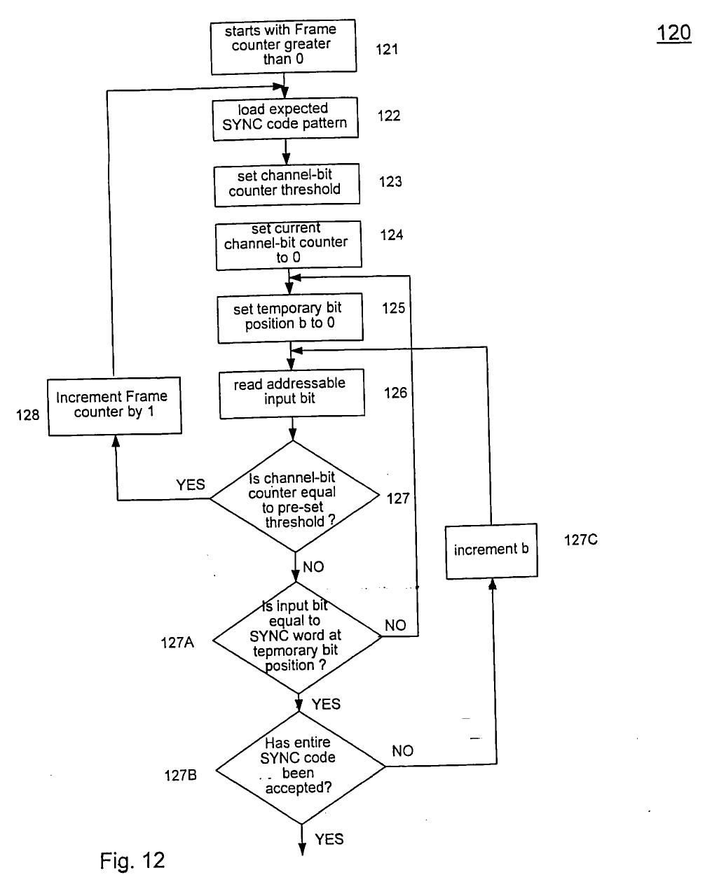

Methods to read the sector address as well as requested data depend on the physical structure of a sector. As an example of sector physical structure, FIG. 11 shows the layout of DVD-ROM specified in ECMA 267, which is available from ECMA at 114 Rhone 1024, Geneva (Switzerland) or from the website www.ecma.ch. A method of reading the address and data codes in the structure will be disclosed.

As shown in FIG. 9, sector address reading begins with step 91 by loading the expected SYNC code pattern and continues at step 92 to set the microprocessor 51 into its single-step mode. At step 93, temporary bit position b is set to 0. At step 94, addressable bits are read one bit at one channel-clock cycle. Every time, a bit is read, the programmable-sequencer compares it with the one at the corresponding position of the unique SYNC code. If the current input bit mismatches the one in the SYNC code, the process starts from step 93 again by setting the temporary bit position to zero. If the current bit does match the expected value, the sequencer checks whether the entire SYNC word has been accepted. If only part of a SYNC word was read, the temporary bit position b is incremented by one at step 95B and processing returns to step 94 to read the next input-bit. If an entire SYNC word has been read. the sequencer mover to step 96 to set a temp integer to zero in a fixed number of instructions and gets ready to read address codes. Table 1 lists assembly-language instructions to detect a SYNC. As we can see, this sequence of instructions implicitly includes the logic loop from step 94 to step 95B of FIG. 9. When the processing reaches instruction BIT15 and results in no jump, the status that the entire SYNC code has been accepted is automatically established.

TABLE 1
Example Instructions for the Detection of a SYNC Code with a Pattern of
10 . . . 01

| Label | Instruction | | Expected SYNC Pattern |
|---|---|---|---|
| BIT0 | JNB BIT0 | ;jump if bit=0 | 1 |
| BIT1 | JB BIT0 | ;jump if bit=1 | 0 |
| . . . | . . . | . . . | . . . |
| BIT14 | JB BIT0 | ;jump if bit=1 | 0 |
| BIT15 | JNB BIT0 | ;jump if bit=0 | 1 |

As shown in FIG. 11, before the first address code 113 enters the shift register 52 of FIG. 5, codes 112 separating the preceding reference SYNC code and an address code are streaming in. These codes may contain other information, which may be used by the controller. The exact management of these codes is part of the format information. For demonstration purposes. the example method shown in FIG. 9 just counts the input channel-bits until the first address code starts.

A shift register 52 with a size equal to or greater than the length of one address code word is allocated to store input channel-bits. At each channel-bit clock cycle, the shift register moves existing bits one position up and accepts one new input bit. When a whole channel-bit code has been read, it is used at step 98 as a pointer to a pre-loaded look-up table and consequently converted to a byte code. After conversions of each code word, the programmable-sequencer checks if the entire sector address is complete. If more address codes are expected. the method continues at step 97. If a complete address has been read, it is sent to the controller for verification at step 99B.

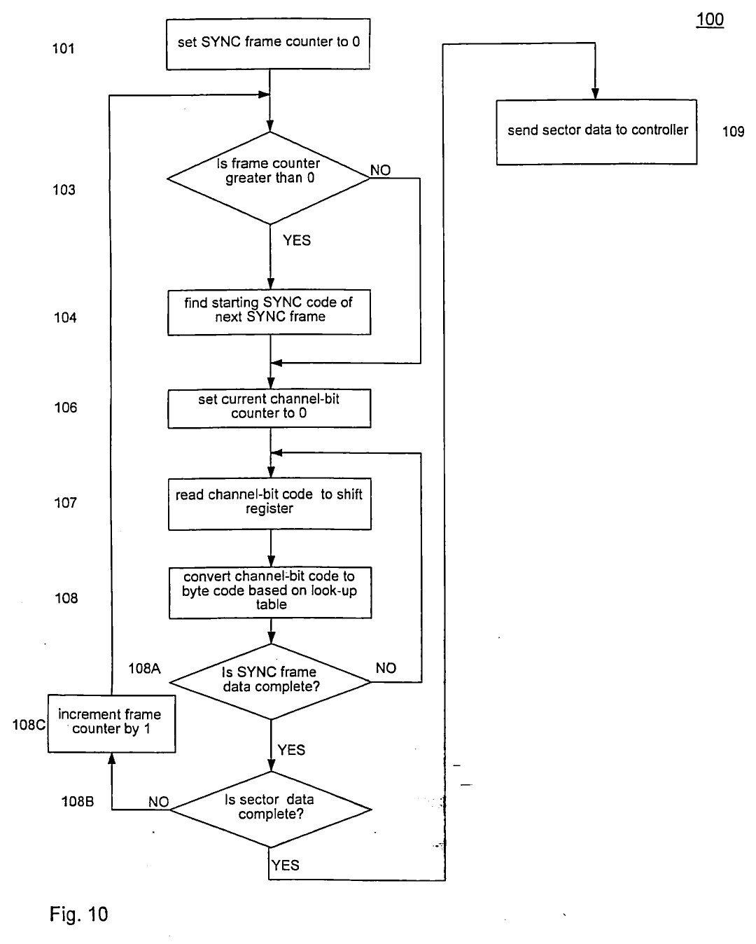

Once the requested sector has been found, the user data in the requested sector is read with method 100 shown in FIG. 10. As shown in FIG. 11, user data within a sector 110 are recorded in several SYNC frames that are separated by characteristic SYNC codes 115 and 115A. The size of such frames is described in the format description so that the controller knows how many data codes are expected in one SYNC frame. The relative position of data codes in the channel-bit stream can be determined by reading the status of the counter, and characteristic SYNC codes can be used to verify the position.

The programmable-sequencer (36, 40) starts to read data code words at step 101, where the SYNC frame counter is set to 0. For the sector layout 110, the programmable-sequencer (36, 40) can begin to read data in SYNC frame 0 immediately after the requested sector address is confirmed. To read data codes in the remaining SYNC frames, a leading SYNC code is always detected first. At step 103, the programmable-sequencer checks the status of the frame counter. If the frame counter is 0, the programmable-sequencer mover to step 105 and prepares to read data code words (113-114) in SYNC frame . If the frame counter is greater than 0, the programmable-sequencer starts at step 104 to look for the starting SYNC code of the next SYNC frame before reading data codes. The detailed process at step 104 is shown as method 120 in FIG. 12. It is similar to steps 93-95A in finding the address SYNC code as shown in FIG. 9. However. method 120 also provides a way to abandon a search for SYNC code which is late because of channel-bit or channel-clock errors.

With the positive return from SYNC code identification, the current channel-bit counter is reset to zero at step 106.

Since both the data-codes starting position and its length are known to the programmable-sequencer 36 of FIG. 3. at step 107 channel-bits are read into the shift register 52 of FIG. 5 in series and moved out in parallel at every code length. At step 108. channel-bit codes are converted to associated byte codes based on a pre-loaded look-up table. The principle of the conversion is same as that described in FIG. 9 where channel-bit codes are converted to byte codes corresponding to a sector address.

After each code conversion, the programmable-sequencer (36, 40) determines at step 108A whether a SYNC frame is complete by implicitly reading the current channel-bit counter. If more codes are expected from the current SYNC frame, steps 107 and 108 are repeated. When the current SYNC frame is complete, the sequencer determines whether the current sector data is complete by reading the SYNC frame counter. if more SYNC frames are expected, the process restarts from step 102. If the current sector data is complete. the sequencer returns its data to the controller at step 109 and waits for the next instruction.

Besides being used as process control parameter, the status of the current channel-bit counter and the frame counter embedded in method 100 can be used to find and handle errors. Typical errors are missing or extra channel-bits. FIG. 12 shows a method of handling errors while reading the SYNC code of a SYNC frame.

Method 120 in FIG. 12 can be considered as an expanded version of step 104 of method 100 shown in FIG. 10. The method 120 starts at step 121 with the frame counter greater than 0. At step 122, the expected SYNC code pattern is loaded, and at step 123, the programmable-sequencer sets a channel-bit counter threshold. This channel-bit counter threshold is a number that indicates the boundary of a predefined number of channel-bits. For example, if the current task is to read a Sync code starting with the first bit of the code, the threshold is equal or greater than the length of SYNC code plus 1. In practical operation, the threshold can be set by an interrupt pointing to the first instruction of a routine that minimizes the amount of data lost or read incorrectly.

The method 120 continues with step 124 where the current channel-bit counter is set to zero, and step 125 where the temporary bit position b is also set to zero. At step 126, addressable input starts to be read. After each channel-bit is read, the programmable-sequencer 36 determines whether the channel-bit counter reached the preset threshold.

If the threshold is not yet reached, the current bit is compared with the one at the corresponding position of the expected SYNC code. If the current input bit mismatches the one in the expected SYNC code, the process starts from step 125 again by setting the temporary bit position to zero. If the current bit does match the expected value, the sequencer determines whether the entire SYNC word has been accepted. If only part of a SYNC code has been read, the temporary bit position b is incremented by one and reading continues at step 126; if an entire SYNC code has been read, the sequencer is ready to start the process of reading data-codes in the current SYNC frame.

If the threshold is reached, it means that the current channel-bit is already beyond the last channel-bit of the expected SYNC code, but the expected SYNC code has not been identified. This can happen because of bit errors or errors. In this situation, the programmable-sequencer gives up reading the missed current SYNC code and restarts at step 122 to read the SYNC code of the next SYNC frame after incrementing the frame counter by 1 at step 128. In order to avoid over running the next SYNC code, the channel-bit counter threshold is set to a value which is longer than the SYNC code and shorter than the length of the entire SYNC frame. As an alternative, which is not shown in FIG. 12, the programmable-sequencer can assume that a beginning of data code has been identified and continue to read data codes and to pass possibly erroneous data to the controller. Accordingly, the channel-bit counter threshold should be set to the total length of codes in the current SYNC frame.

Depending on the robustness of the error-correction-code (ECC) used, the specific physical structure of a sector and the requirement on the data reliability, error-handling at the drive level can adopt difference approaches to optimize performance. Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

What is claimed is:

1. A copy-resistant read-only digital optical disc having encrypted contents, said copy-resistant read-only digital optical disc comprising:
an encrypted user data recorded in a user data format in a second zone of said copy-resistant read-only digital optical disc;
an implementation data of the user data format recorded in a default format in a first zone of said copy-resistant read-only digital optical disc;
wherein, the user data format is incompatible with the default format; and
said encrypted user data is encrypted by an algorithm recorded in the user data format.

2. The copy-resistant read-only digital optical disc according to claim 18, wherein the user data format includes an implementation of error correction decoding.

3. The copy-resistant read-only digital optical disc according to claim 18. wherein said implementation data is recorded at an innermost predetermined section of said copy-resistant read-only digital optical disc in the default format.

4. An adaptable digital optical disc player which adapts to read user data from the copy-resistant read-only digital optical disc recited in claim 18, wherein said adaptable digital optical disc player comprises a drive operable to read user data format implementation recorded in the default format to access the user data.

5. The adaptable digital optical disc player according to claim 21, wherein said drive is further operable to read a software algorithm for encrypting user data recorded in the user data format.

6. A method of forming a copy-resistant read-only digital optical disc, said method including:
encrypting a user data;
recording the encrypted user data in a user data format in a second zone on a disc; and
recording an implementation data of the user data format in a default format in a first zone on the disc;
wherein the user data format is incompatible with the default format; and
said encrypting is executed by an algorithm recorded in the user data format.
